(19) United States
(12) Patent Application Publication
(10) Pub. No.: US 2005/0134052 A1
(43) Pub. Date: Jun. 23, 2005

(54) Pulsed electromagnetic application in vehicle door latch

(75) Inventors: Nigel V. Spurr, Shirley (GB); Michael J. Shelley, Fauldhouse (GB); Richard T. Hayes, Motherwell (GB); William F. Eaton, Pearl City, IL (US); Hugh D. Gibson, Edinburgh (GB); Alex Crawford, East Kilbride (GB); Ajaykumar Valdhyanathan, Chennai (IN); Scott A. Vorwald, Lena, IL (US); Kenneth V. Bechtold, Freeport, IL (US); Curtis B . Johnson, Freeport, IL (US); Duncan S. Murchie, Crieff (GB); Daniel D. Kilker, University Park, FL (US); Abanni B. Maxwell, Rockford, IL (US); Patrick H. Shannon, Motherwell (GB); Gillian J. Madden, Bothwell (GB); Adrian T. Ketle, Shrivenham (GB)

Correspondence Address: Kris T. Fredrick;Honeywell International, Inc., 101 Columbia Rd., P.O. Box 2245, Morristown, NJ, 07962, US

(73) Assignee: Honeywell International Inc.

(21) Appl. No.: 10/745,357

(22) Filed: Dec. 23, 2003

(51) Int. Cl. E05C 3/06

(52) U.S. Cl. 292/201

(57) ABSTRACT

Methods and systems for magnetically actuating latch components are disclosed herein. A door latch assembly comprising at least one latching mechanism can be provided for maintaining a door in a locked condition or an unlocked condition. One or more electromagnets can be integrated with the door latch assembly, such that the electromagnet generates one or more pulses in the form of electrical energy that can actuate the latching mechanism from a locked condition to an unlocked condition and vice versa. A pulsed electromagnet is therefore utilized such each pulse of energy applied actuates the latching mechanism a known amount. Such a configuration permits the latching mechanism to be accurately indexed from a known position to another.

### TECHNICAL FIELD

Embodiments are generally related to door latch assemblies, including door latching mechanisms utilized in automobiles and other vehicles. Embodiments are also related to pulsed electromagnets and controller devices.

### BACKGROUND OF THE INVENTION

Latching mechanisms are utilized in a variety of commercial and industrial applications, such as automobiles, airplanes, trucks, and the like. For example, an automotive closure, such as a door for an automobile passenger compartment, is typically hinged to swing between open and closed positions and conventionally includes a door latch that is housed between inner and outer panels of the door. The door latch functions in a well-known manner to latch the door when it is closed and to lock the door in the closed position or to unlock and unlatch the door so that the door can be opened manually.

The door latch can be operated remotely from inside the passenger compartment by two distinct operators—a button or an electric switch that controls the locking function and a handle that controls the latching function. The door latch is also operated remotely from the exterior of the automobile by a handle or push button that controls the latching function. A second distinct exterior operator, such as a key lock cylinder, may also be provided to control the locking function, particularly in the case of a front vehicle door. Each operator is accessible outside the door structure and extends into the door structure where it is operatively connected to the door latch mechanism by a cable actuator assembly or linkage system located inside the door structure.

Vehicles, such as passenger cars, are therefore commonly equipped with individual door latch assemblies which secure respective passenger and driver side doors to the vehicle. Each door latch assembly is typically provided with manual release mechanisms or lever for unlatching the door latch from the inside and outside of the vehicle, e.g. respective inner and outer door handles. In addition, many vehicles also include an electrically controlled actuator for remotely locking and unlocking the door latches.

One of the problems inherent with conventional latching mechanisms is that it is difficult, but necessary, to provide accurate and efficient locking and unlocking mechanisms, which are particularly responsive to electrical signals. Current solutions to date encumbered with the burden of relying upon rotating motors to move a latching mechanism to the required condition (e.g., open, closed, locked, unlocked, etc.). This requires a complex control method and expensive motor switching devices. A much more efficient and simplified solution is thus necessary to overcome the difficulties inherent with conventional latching mechanisms.

### BRIEF SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

It is, therefore, one aspect of the present invention to provide for an improved latch mechanism.

It is another aspect of the present invention to provide for improved latching methods and systems for use in automobiles and other vehicles.

It is yet a further aspect of the present invention to provide for a latch mechanism of a latching assembly which is responsive to one or more electromagnetic pulses generated by an electromagnet.

The aforementioned aspects of the invention and other objectives and advantages can now be achieved as described herein. Methods and systems for magnetically actuating latch components are disclosed herein. A door latch assembly comprising at least one latching mechanism can be provided for maintaining a door in a locked condition or an unlocked condition. One or more electromagnets can be integrated with the door latch assembly, such that the electromagnet generates one or more pulses in the form of mechanical energy that can actuate the latching mechanism from a locked condition to an unlocked condition and vice versa.

A pulsed electromagnet is therefore utilized such each pulse of energy applied actuates the latching mechanism a known amount. Such a configuration permits the latching mechanism to be accurately indexed from a known position to another, thereby providing a vehicle door latch designer with the ability to design and construct door latches with powered closures, unlatching, locking, and super-locking components having a minimal size and a simplified control means. A controller can be provided, which communicates with both the latching mechanism and the electromagnet.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a perspective view of a vehicle door mounted to a passenger vehicle in which a preferred embodiment of the present invention can be implemented;

FIG. 2 illustrates a block diagram of a system, which can be implemented in accordance with a preferred embodiment of the present invention;

FIG. 3 illustrates a block diagram of a vehicle latch assembly, which can be implemented in accordance with a preferred embodiment of the present invention;

FIG. 4 illustrates a block diagram of a vehicle latch assembly, which can be implemented in accordance with an alternative embodiment of the present invention;

FIG. 5 illustrates a schematic diagram of a system, which can be implemented in accordance with an alternative embodiment of the present invention; and

FIG. 6 illustrates a block diagram of a system, which can be implemented in accordance with an alternative embodiment of the present invention.

### DETAILED DESCRIPTION OF THE INVENTION

The particular values and configurations discussed in these non-limiting examples can be varied and are cited merely to illustrate at least one embodiment of the present invention and are not intended to limit the scope of the invention.

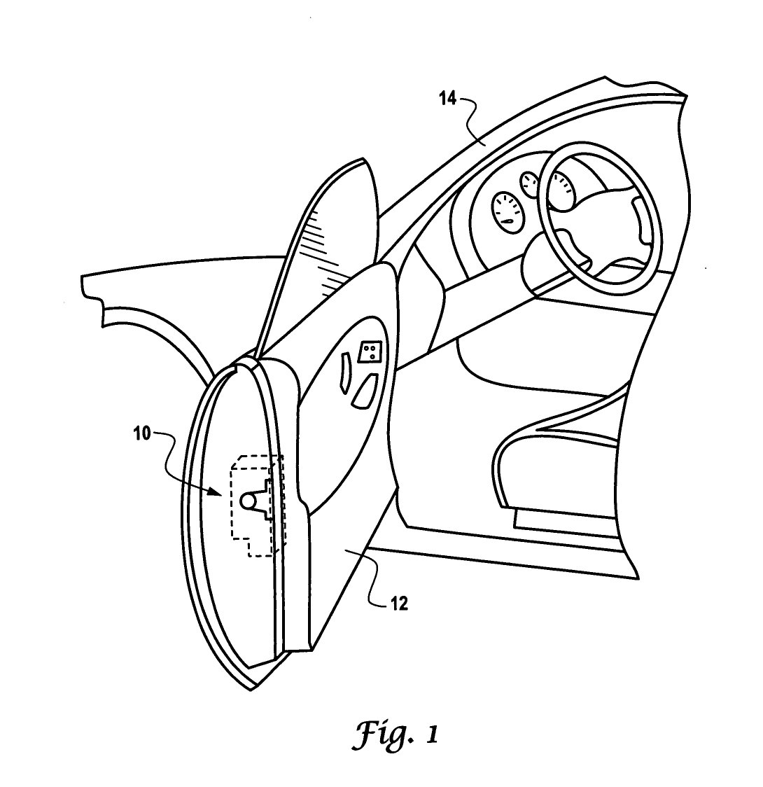

FIG. 1 illustrates a perspective view of a vehicle door 12 mounted to a passenger vehicle in which a preferred embodiment of the present invention can be implemented. A vehicle, such as an automobile can be equipped with one or more individual door latch assemblies 10, which secure respective passenger and driver side doors to the vehicle 14. Each door latch assembly 10 is typically provided with manual release mechanisms or lever for unlatching the door latch from the inside and outside of the vehicle, e.g. respective inner and outer door handles.

In addition, many vehicles can also be equipped with electrically controlled actuators for remotely locking and unlocking the door latches. As indicated in FIG. 1, a door latch assembly 10 can be mounted to a driver's side vehicle door 12 of a passenger vehicle 14. The door latch assembly 10 may be mounted to front and rear passenger side doors thereof and may be incorporated into a sliding side door, rear door, a rear hatch or a lift gate thereof, depending upon design constraints.

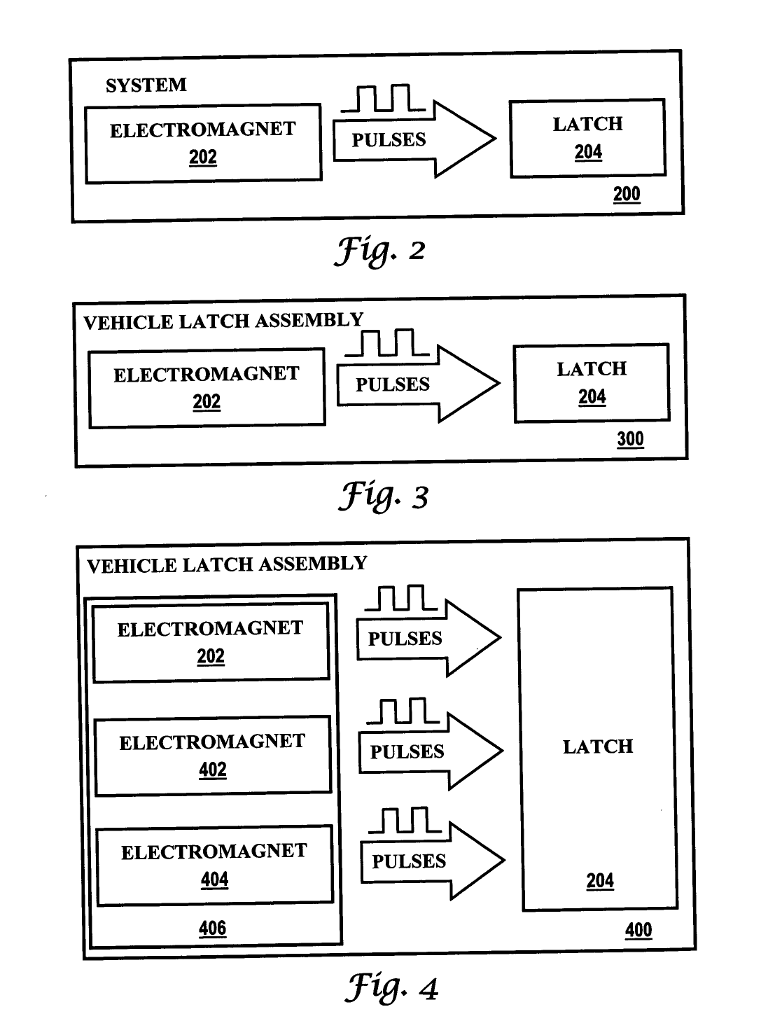

FIG. 2 illustrates a block diagram of a system 200, which can be implemented in accordance with a preferred embodiment of the present invention. System 200 includes a pulsed electromagnet 202 wherein each pulse of electric energy generated by electromagnet 202 can actuate a latch a known amount, thereby permitting latch 204 to be accurately indexed from one known position to another. FIG. 3 illustrates a block diagram of a vehicle latch assembly 300, which can be implemented in accordance with a preferred embodiment of the present invention. Latch assembly 300 of FIG. 3 is generally analogous to latch assembly 10 of FIG. 1. Note that in FIGS. 1-3, similar or identical parts are indicated by identical reference numerals. Latch 204 represents one or more latches or levers or other locking/unlocking mechanisms that can be integrated with or form part of a latch assembly, such as, for example, latch assembly 10 of FIG. 1.

FIG. 4 illustrates a block diagram of a vehicle latch assembly 400, which can be implemented in accordance with an alternative embodiment of the present invention. Latch assembly 400 of FIG. 4 is analogous to latch assembly 10 of FIG. 1. Latch assembly 400, however, includes a plurality of electromagnets 202, 402, and 404, which collectively comprise a group 406 of electromagnets that generate one or more pulses for actuating latch 204 or another locking or unlocking component of vehicle latch assembly 400.

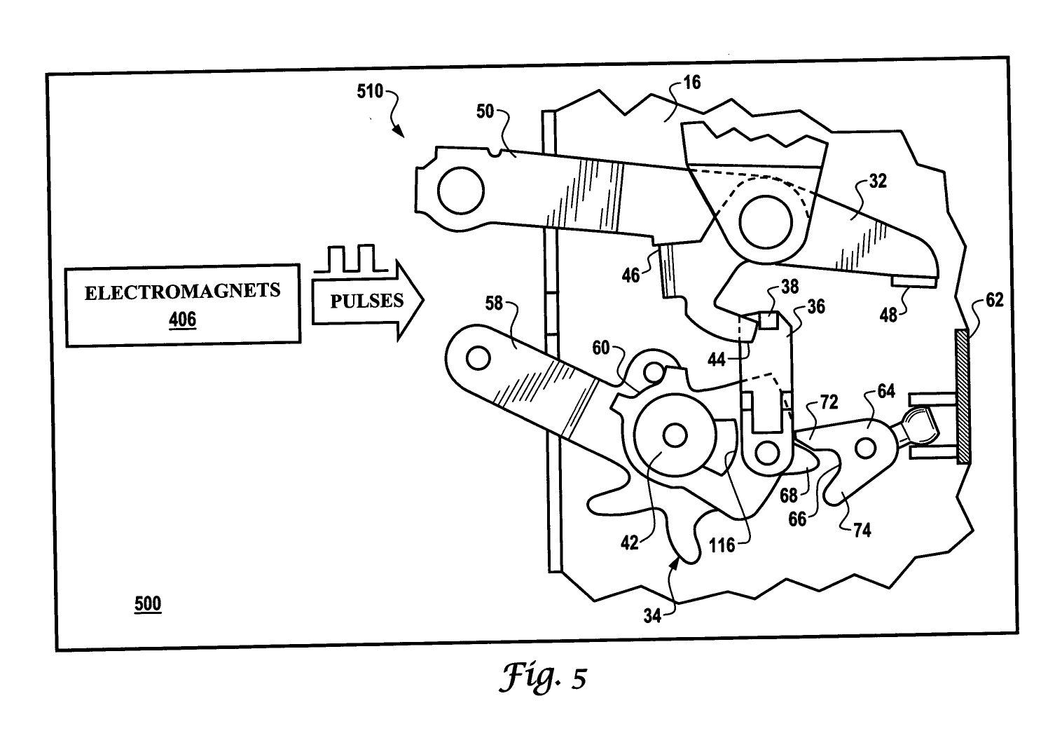

FIG. 5 illustrates components of a system 500 that includes a latch assembly 510, which can be implemented in accordance with an alternative embodiment of the present invention. System 500 also includes a group 204 of electromagnets 406 which provide one or more pulses for actuating various components of latch assembly 510. Latch assembly 510 is not considered a limiting feature of the present invention, but is illustrated and described herein for general illustrative and edification purposes only, and to describe one possible context in which an alternative embodiment of the present invention can be implemented.

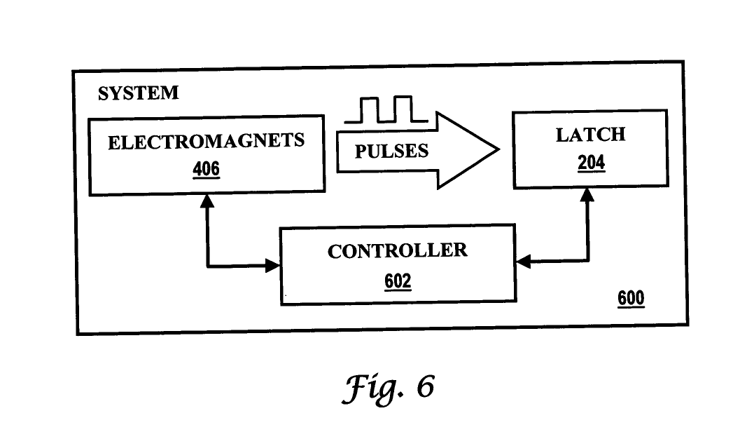

Latch assembly 510 generally includes a release mechanism 32 that is mounted to a support housing 16. Latch assembly 510 of FIG. 6 can be adapted for use with the vehicle door latch assembly of FIG. 1 and can be characterized as including a coupler, generally shown at 34. The movement of the coupler 34 in relation to the release mechanism 32 is illustrated FIGS. 5. The coupler 34 has an engaged position aligned with the release mechanism 32. This coupled position can create an unlocked condition, which is shown in FIG. 5. The coupler 34 can then move to a disengaged position spaced from the release mechanism.

The coupler 34 can move to a further disengaged position spaced farther from the release mechanism 32. Preferably, the coupler 34 includes a slider 36 having a projecting pin 38 with the pin 38 sliding relative to the release mechanism 32 between an engaged position and a disengaged position thereof. As appreciated, the slider 36 and pin 38 may be of any suitable design or configuration. The coupler 34 can also include a locking mechanism 42 pivotally connected to the support housing 16 and engaging the slider 36 for providing the sliding movement of the slider 36 and the pin 38. As appreciated, the coupler 34 may include the slider 36 with the pin 38 and the locking mechanism 42.

An outside lock lever 58 can be pivotally connected to the locking mechanism 42 for rotating the locking mechanism 42 and moving the slider 36 into a locking position. The locking mechanism 42 further can include an integral slot 60 selectively engaged by the outside lock lever 58 to provide a lost motion connection between the locking mechanism 42 and the outside lock lever 58. The outside lock lever 58 can engage one side of the slot 60 of the locking mechanism 42 to move the locking mechanism 42 to an unlocked condition. Then, the outside lock lever 58 can engage the other side of the slot 60 of the locking mechanism 42 to move the locking mechanism 42 to a first locked condition. The locking mechanism 42 can also be moved to the double locked condition wherein the outside lock lever 58 is disposed within the slot 60.

The release mechanism 32 cam also include a coupling surface 44 for selectively engaging the pin 38 of the slider 36. The release mechanism 32 also includes a first engaging surface 46 spaced from the coupling surface 44 and a second engaging surface 48 spaced from the first engaging surface 46. An outside release lever 50 can be pivotally mounted to the support housing 16 and selectively engage the first engaging surface 46 of the release mechanism 32 for moving the release mechanism 32.

An interior locking segment 64 can be pivotally mounted to the support housing 16 and interconnect the inside lock lever 62 to the locking mechanism 42. The interior locking segment 64 can also be configured to include an integral catch 66 and the locking mechanism 42 includes an engagement finger 68 with the engagement finger 68 selectively engaging the catch 66 such that pivotal movement of the locking mechanism 42 pivots the locking segment 64 and actuates the inside lock lever 62. Preferably the catch 66 has first 72 and second 74 legs with the finger 68 disposed between the legs 72, 74. During actuation of an inner door handle, an inside release lever (not shown in FIG. 5) can pivot toward the release mechanism 32 and engage a second engaging surface 48 of the release mechanism 32. Preferably, the locking mechanism 42 includes an aperture 116.

It can be appreciated that a variety of different types of latch assemblies can be implemented in accordance with varying embodiments of the present invention. One non-limiting example of a latch assembly that can be adapted for use with the present invention is shown in U.S. Pat. No. 6,511,107, “Electrically controlled actuator for a vehicle door latch assembly,” which issued to Barczynski et al on Jan. 28, 2003 and is incorporated herein by reference. It can be appreciated that U.S. Pat. No. 6,511,107 is referenced herein for general illustrative and edification purposes only and is not considered a limiting feature any embodiments of the present invention.

FIG. 6 illustrates a block diagram of a system 600, which can be implemented in accordance with an alternative embodiment of the present invention. System 600 provides a configuration for magnetically actuating latch components. System 600 can be implemented as a door latch assembly that includes at least one latching mechanism 204 for maintaining a door in a locked condition or an unlocked condition. At least one electromagnet 406 can be integrated with system 600 such electromagnet 406 generates at least one pulse in the form of electrical energy that actuates the at least one latching mechanism from a locked condition to an unlocked condition and vice versa. Controller 602 can communicate with the electromagnet 406 for the generation of one or more pulses for actuating the latching mechanism 204. Controller 602 can also communicate with latching mechanism 204 to provide one or more electrical signals thereof for moving the latching mechanism from a first position to a second position. Each pulse generated by electromagnet(s) 406 can actuate latching mechanism 204 a known amount thereby permitting latching mechanism 204 to be indexed from one known position to another within a door latch assembly, such as door latch assembly 10 of FIG. 1.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered.

The description as set forth is not intended to be exhaustive or to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

1. A method for electro-magnetically actuating latch components, said method comprising the steps of:
providing a door latch assembly comprising at least one latching mechanism for maintaining a door in a latched condition or an unlatched condition;
integrating at least one electromagnet with said door latch assembly, such that said at least one electromagnet generates at least one pulse in the form of mechanical energy that actuates said at least one latching mechanism from a locked condition to an unlocked condition and vice versa.

2. The method of claim 1 wherein said at least one electromagnet comprises a pulsed electromagnet for generating said at least one pulse in the form of said mechanical energy for latch closure or unlatching of said at least one latching mechanism.

3. The method of claim 1 wherein said at least one pulse actuates said at least one latching mechanism a pre-determined distance to thereby permit said at least one latching mechanism to be indexed from one pre-determined position to another pre-determined position.

4. The method of claim 1 further comprising the step of providing a controller which communicates with said at least one electromagnet for the generation of said at least one pulse for actuating said at least one latching mechanism.

5. The method of claim 1 further comprising the step of providing a controller which communicates with said at least one latching mechanism and provides a signal thereof for moving said at least one latching mechanism from a first position to a second position.

6. The method of claim 1 wherein further comprising the step of providing a controller, which communicates with said at least one latching mechanism and said at least one electromagnet.

7. The method of claim 1 further comprising the step of configuring said at least one latching mechanism to comprise a release mechanism mounted to a support housing of said door latch assembly.

8. The method of claim 1 further comprising the step of configuring said at least one latching mechanism to comprise a locking mechanism integrated with said door latch assembly.

9. The method of claim 1 wherein said at least one pulse actuates said at least one latching mechanism a known amount thereby permitting said latching mechanism to be indexed from one known position to another.

10. A method for actuating magnetically actuating latch components, said method comprising the steps of:
providing a door latch assembly comprising at least one latching mechanism for maintaining a door in a locked condition or an unlocked condition;
integrating at least one electromagnet with said door latch assembly, such that said at least one electromagnet generates at least one pulse in the form of mechanical energy that actuates said at least one latching mechanism from a locked condition to an unlocked condition and vice versa;
providing a controller which communicates with said at least one electromagnet for the generation of said at least one pulse for actuating said at least one latching mechanism; and
wherein said at least one pulse actuates said at least one latching mechanism a known amount thereby permitting said latching mechanism to be indexed from one known position to another.

11. A system for actuating magnetically actuating latch components, said system comprising:
a door latch assembly comprising at least one latching mechanism for maintaining a door in a locked condition or an unlocked condition;
at least one electromagnet integrated with said door latch assembly, such that said at least one electromagnet generates at least one pulse in the form of mechanical energy that actuates said at least one latching mechanism from a locked condition to an unlocked condition and vice versa.

12. The system of claim 11 wherein said at least one electromagnet comprises a pulsed electromagnet for generating said at least one pulse in the form of said mechanical energy for latch closure or unlatching of said at least one latching mechanism.

13. The system of claim 11 wherein said at least one pulse actuates said at least one latching mechanism a pre-determined distance to thereby permit said at least one latching mechanism to be indexed from one pre-determined position to another pre-determined position.

14. The system of claim 11 further comprising a controller which communicates with said at least one electromagnet for the generation of said at least one pulse for actuating said at least one latching mechanism.

15. The system of claim 11 further comprising a controller, which communicates with said at least one latching mechanism and provides a signal thereof for moving said at least one latching mechanism from a first position to a second position.

16. The system of claim 11 wherein further comprising a controller which communicates with said at least one latching mechanism and said at least one electromagnet.

17. The system of claim 11 wherein said at least one latching mechanism comprises a release mechanism mounted to a support housing of said door latch assembly.

18. The system of claim 11 wherein said at least one latching mechanism comprises a locking mechanism integrated with said door latch assembly.

19. The system of claim 11 wherein said at least one pulse actuates said at least one latching mechanism a known amount thereby permitting said latching mechanism to be indexed from one known position to another.

20. The system of claim 11 wherein said at least one electromagnets comprises a plurality of electromagnets.
